(19) United States
(12) Patent Application Publication
(10) Pub. No.: US 2025/0322094 A1
(43) Pub. Date: Oct. 16, 2025

(54) FLOW ADMINISTRATION SYSTEM AND METHOD

(71) Applicant: GEMBA SOFTWARE SOLUTIONS INC., Saint John (CA)

(72) Inventor: Adrian PHINNEY, Toronto (CA)

(21) Appl. No.: 19/075,235

(22) Filed: Mar. 10, 2025

Related U.S. Application Data
(60) Provisional application No. 63/634,604, filed on Apr. 16, 2024.

(51) Int. Cl. G06F 21/62

(52) U.S. Cl. CPC G06F 21/6218

(57) ABSTRACT

A system and method for managing sensitive data is disclosed. The system comprises a secure portion comprising a repository and a secure application comprising sensitive data of the platform user. A retrieved flow is rendered on a display of a user device and comprises symbols representative of steps, comprising texts describing the step and at least one flow arrow interconnecting pairs of symbols. A direction of flow indicates the defined sequence in which the steps are to be executed. At least one of the steps comprises an extended data step and selecting the extended data step invokes a data supplementer on the platform user device. The data supplementer communicates with the repository and the secure application for retrieving the sensitive data of the user. The data supplementer renders the sensitive data on the display by invoking selected components of an extended flow component library using an extended flow API.

### CROSS REFERENCE TO RELATED APPLICATIONS

This application claims benefit of U.S. provisional application Ser. No. 63/634,604, filed on Apr. 16, 2024 All documents above are incorporated herein in their entirety by reference.

### FIELD OF THE INVENTION

The present invention relates to a flow administration system and method. In particular, the present invention relates to a client support platform and method for managing sensitive data of a platform user in the flow administration system.

### BACKGROUND TO THE INVENTION

Industries which are motivated to provide comprehensive client support such as call centers, telecommunication providers, financial institutions, retail merchants, utilities and the like often provide hot lines or other points of contact such as chat lines which allow both existing and potential clients to communicate directly with support personnel. In order to provide a consistent and efficient client experience while at the same time reducing errors and complexity, many industries provide software-based tools to their support personnel.

The prior art discloses support tools which include a display for providing visual cues to support personnel detailing the process path to be followed when interacting with a client via a point of contact. These could include, for example, standard questions and responses to typical client questions, the order in which such questions should be asked and such responses provided and alternative paths to be followed given particular client responses and the like. Additionally, such prior art systems are able to display to support personnel information which might already be available on an existing client, or provide interactive dialogs allowing support personnel to enter information regarding a client.

One drawback of such prior art support tools is that the interaction between the support tool and repositories such as databases or the like is hard coded into the support tool, for example during development. For tools developed “in house” this generally proves not to be a problem as access to these repositories of data or secure applications both during development and when the support tool is being used “live” is via those who are either employees of the owner of the repositories or otherwise under their control. However, for support tools developed by 3^{rd} party providers this can be problematic as in many cases such repositories contain sensitive and confidential data and to which access is restricted. Additionally, as many of the 3^{rd} party support tools are subscribed to and purchased as a service which is accessed remotely via a Wide Area Network (WAN), hardcoding access to external repositories which contain sensitive and confidential data may inadvertently introduce weaknesses into existing security measures leaving the repository and its data vulnerable to unwanted access.

### SUMMARY OF THE INVENTION

The present invention overcomes the above and other drawbacks by providing a client support platform for managing sensitive data of a platform user comprising a flow application, at least one flow comprising a plurality of steps to be followed by the platform user in a defined sequence and comprising at least one decision step and at least one sensitive data action step, wherein each of the at least one steps is either proceeded or followed by at least one other of the steps according to the defined sequence, a first repository for storing the at least one flow, the repository accessible by the flow application for flow retrieval, a secure portion comprising at least one of a second repository and a secure application comprising sensitive data of the platform user, a platform user device comprising a display and interconnected with the flow application via the communications network for retrieving the flow from the repository using the flow application, wherein a graphical representation of the retrieved flow is rendered on the display, the rendered graphical representation comprising a plurality of symbols each representative of respective ones of the steps wherein at least one of the steps comprises an extended data step, a plurality of texts each describing a respective one of the steps, and at least one flow arrow interconnecting a respective pair of the symbols wherein a direction of flow indicated by the flow arrow is representative of the defined sequence in which the steps represented by the symbols are to be executed, wherein selecting the extended data step invokes a data supplementer on the platform user device, wherein the data supplementer communicates with at least one of the second repository and the secure application for retrieving the sensitive data of the platform user, wherein the flow application comprises an extended flow component library invokable using an extended flow API, wherein the data supplementer renders the sensitive data on the display by invoking selected components of the extended flow component library using the extended flow API.

There is also disclosed a method for managing sensitive data of a platform user comprising retrieving at least one flow from a first repository via a communications network, the at least one flow comprising a plurality of steps to be followed by the platform user in a defined sequence and comprising at least one decision step and at least one sensitive data action step, wherein each of the at least one steps is either proceeded or followed by at least one other of the steps according to the defined sequence, rendering a graphical representation of the retrieved flow on a display, the rendered graphical representation comprising a plurality of symbols each representative of respective ones of the steps wherein at least one of the steps comprises an extended data step, a plurality of texts each describing a respective one of the steps, and at least one flow arrow interconnecting a respective pair of the symbols wherein a direction of flow indicated by the flow arrow is representative of the defined sequence in which the steps represented by the symbols are to be executed, and invoking a data supplementer by selecting the extended data step, the data supplementer communicating with a second repository or secure application for retrieving sensitive data. The data supplementer renders the sensitive data on the display using an extended flow API, the extended flow API invoking selected components of an extended flow component library.

Furthermore there is disclosed a computer readable memory having recorded thereon statements and instructions for execution by a computer comprising instructions for retrieving at least one flow from a first repository via a communications network, the at least one flow comprising a plurality of steps to be followed by the platform user in a defined sequence and comprising at least one decision step and at least one sensitive data action step, wherein each of the at least one steps is either proceeded or followed by at least one other of the steps according to the defined sequence, instructions for rendering a graphical representation of the retrieved flow on a display, the rendered graphical representation comprising a plurality of symbols each representative of respective ones of the steps wherein at least one of the steps comprises an extended data step, a plurality of texts each describing a respective one of the steps, and at least one flow arrow interconnecting a respective pair of the symbols wherein a direction of flow indicated by the flow arrow is representative of the defined sequence in which the steps represented by the symbols are to be executed, and instructions for invoking a data supplementer by selecting the extended data step, the data supplementer communicating with a second repository or secure application for retrieving sensitive data. The data supplementer renders the sensitive data on the display using an extended flow API, the extended flow API invoking selected components of an extended flow component library.

### BRIEF DESCRIPTION OF THE DRAWINGS

FIG. 1 provides a schematic diagram of a flow system in accordance with an illustrative embodiment of the present invention;

FIG. 2 provides a flow screen of a flow system in accordance with an illustrative embodiment of the present invention; and

FIG. 3 provides a schematic diagram of a data supplementer in a flow system in accordance with an illustrative embodiment of the present invention.

### DETAILED DESCRIPTION OF THE ILLUSTRATIVE EMBODIMENTS

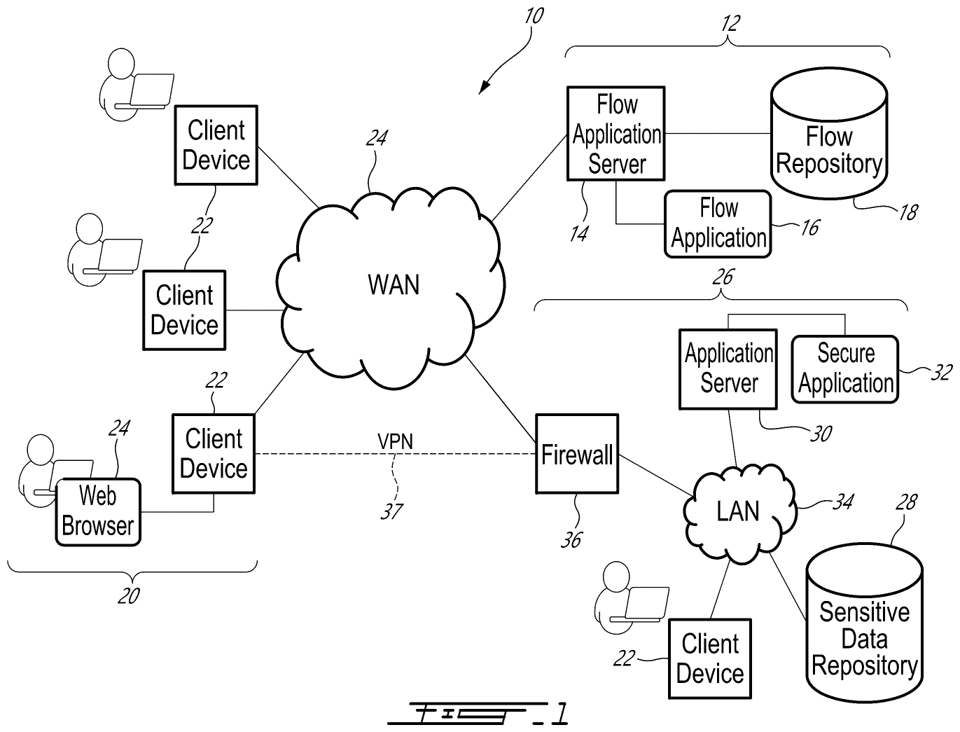

Referring now to FIG. 1, a flow administration system, generally referred to using the reference numeral 10, will now be described. A flow server side 12 of the flow administration system 10 comprises an application server 14 on which one or more flow applications 16 are running and each which can access a data repository 18 (illustratively an SQL database server or the like).

Still referring to FIG. 1, a user portion 20 of the flow administration system 10 comprises one or more client devices 22 which access the one or more web-application servers 14 remotely using a Wide Area Network (WAN) 24 such as the Internet. Each client device as in 22 comprises a web browser 26 which illustratively can receive, compile and display web pages to a user based on JavaScript™, HTML and style sheets (CSS) (all not shown) received from the web-application server(s) 16.

Still referring to FIG. 1, a secure/confidential portion 26 of the flow administration system 10 comprises one or more sensitive data repositories 28 and in a particular embodiment one or more secure application servers 30 which on which one or more secure applications 32, such as a CRM or accounting system or the like, are running. The sensitive data repositories 28 and/or secure application servers 30 are illustratively interconnected via a Local Area Network (LAN) 34 such as a corporate network or the like which in turn is connected to the WAN 24 via a firewall 36 or other network security device. In a first embodiment the client devices 22 are external to the corporate LAN 34 and gain access to the LAN 34 via the firewall 36 for example using a VPN connection 37 or the like. In an alternative embodiment, the client devices may located behind the firewall 36 and attached directly to the LAN 34.

Still referring to FIG. 1, a user of one of the client devices 22 migrates to the address of the flow application server as in 14 via the associated web browser 24. On logging into the flow application server 14, which is achieved for example by entering credentials such as a user ID and password via a login page (not shown), users can be assigned varying rights which may be used to selectively limit a given user's access to particular features provided by the flow application server 14.

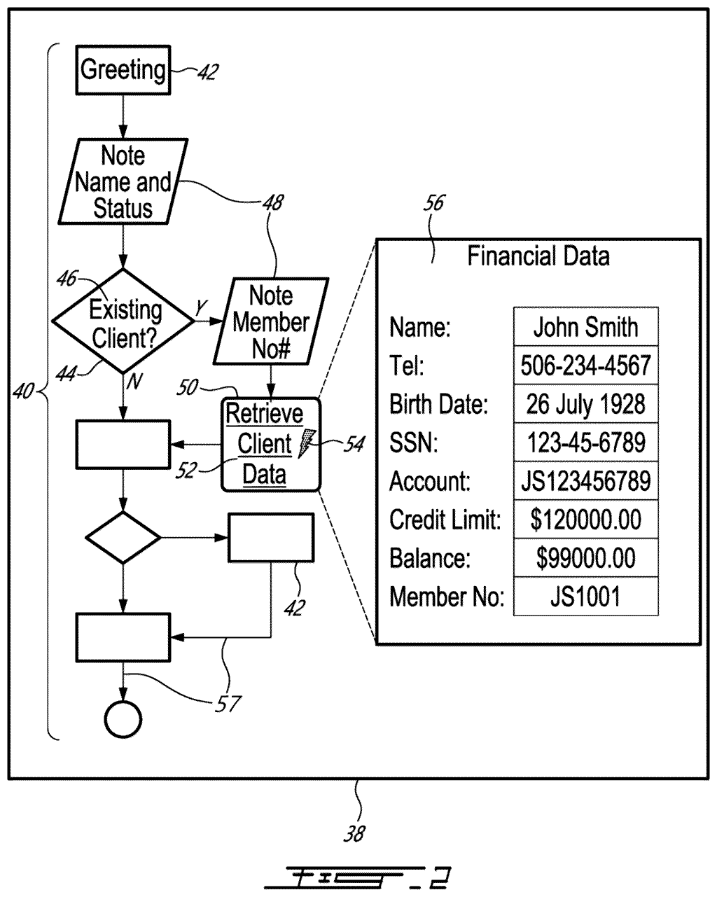

Referring now to FIG. 2 in addition to FIG. 1, logging into the system 10 gains the client device 24 access to a flow viewer 38. The flow viewer 38 generally renders on the display a diagrammatic representation of a flow 40. Each flow 40 is comprised of a variety of elements (or symbols) which represent steps in the procedure flow. Action steps 42 are illustratively represented by a rectangular box which may have a distinctive coloring and/or highlighting depending on the action to be taken and include descriptive text detailing the action to be taken by the user. Action steps 42 may also be coded to indicate actions which are critical, and must be completed, illustratively by highlighting the Action step 42 or coloring the action step with a symbolic color such as red. Decision steps 44 are illustratively represented by a diamond and may also include a distinctive coloring or highlighting and also includes descriptive text 46 detailing the decision to be made by the user. Collection steps 48 are illustratively represented by a rhomboid and may also include a distinctive coloring or highlighting. Collection steps 48 include descriptive text indicating information which should be collected by the user during the step as the information is typically necessary in order to complete one or more of the subsequent steps. Extended data steps 50 illustratively comprise a clickable rounded rectangle which may comprise a descriptive text 52 and graphical indications 54. As will be discussed in more detail below, each extended data step 50 comprises a viewport 56 and clicking or otherwise moving focus to an extended data step 50 provides access to a secure data source and/or application allowing for sensitive data to be displayed and modified in the viewport 56. An extended data step 50 may include textual 52 or graphical 54 indications as to the extended data source, tips, and the like.

Still referring to FIG. 2, other features such as free form text boxes and the like as well as images (both no shown) may be included to provide additional information and graphics to better enhance the user's experience when using the system 10, illustrations of usage, additional tips on data entry and the like. The steps 42, 44, 50 are interconnected by flow arrows 57, typically presented as a solid line arrow, which indicate the order in which the flow is intended to proceed and may include descriptive text, for example to indicate the flow arrow to be followed on exiting a decision step as in 44. Optional flow arrows, which indicate that a particular branch or spur of a procedure flow may be followed at the discretion of the user, are typically presented as a dashed line arrow.

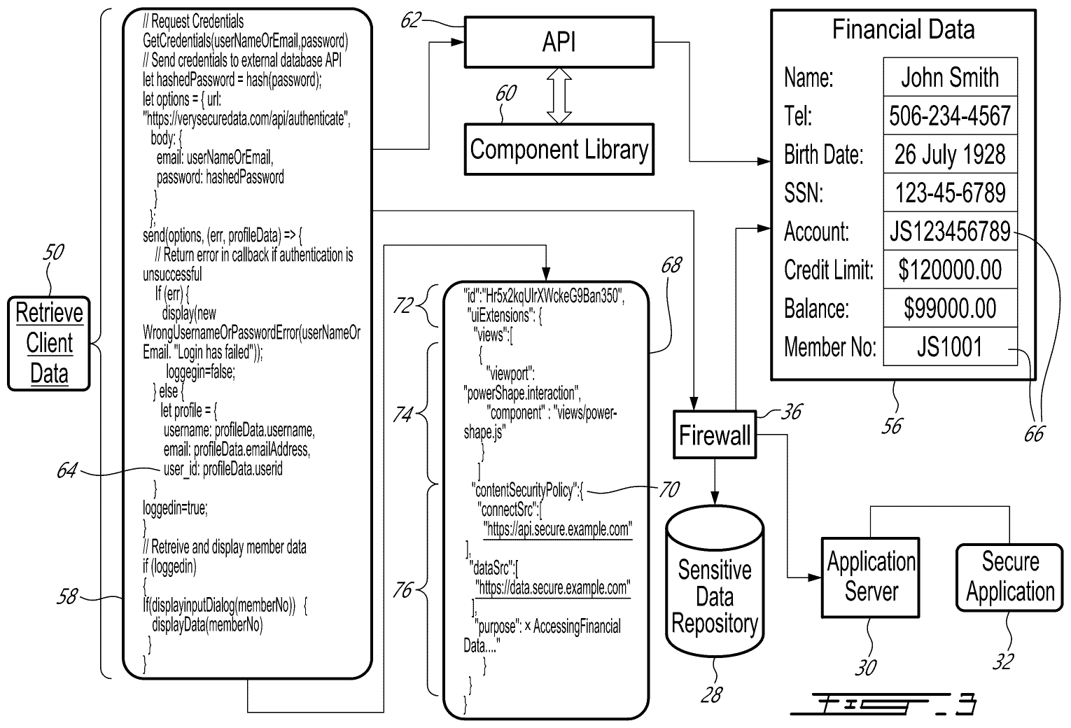

Referring now to FIG. 3 and addition to FIG. 2, as discussed above in order to allow a client's own developers to provide access to sensitive data an extended data step 50 is provided. In general, the extended data step 50 allows the client's own developers to customize or enhance the flow 40 without otherwise having to modify the core functionality of the flow application 16. In particular, the extended data step 50 allows a client's own developers to provide access to a sensitive data repository 28 or secure application 32 comprising secure, confidential and/or sensitive data without otherwise having to access and modify the core functionality of the flow interface. In the illustrated embodiment this is invoked or launched by moving focus of the user interface to an extended data step 50, for example by clicking on the extended data step 50 as rendered on the display.

Still referring to FIG. 3, in preparation of using an extended data step 50, a data supplementer 58 is developed for providing the functionality needed by a given extended data step 50, in particular in order to organize and otherwise interact with data displayed in a viewport 56. In this regard, the flow application 16 implements an extended flow component library 60 and an extended flow API 62 which is used by the data supplementer 58 for example using a script 64 or the like, to access the extended flow component library 60. The extended flow component library 60 may comprise a variety of interface elements 66, such as buttons, forms, navigation menus, modals, cards, sliders, and the like which are able to be rendered in the associated viewport 56. Each component in the component library 60 may be accompanied by CSS styles, JavaScript functionality and the like as well as documentation or usage guidelines in order to facilitate use of the component. Components include Typography components for displaying text, Form Input components for provisioning input, Stack components for provisioning two dimensional (2D) input, Image components for provisioning branding and the like and a Wrapper component for managing the viewport 56.

Still referring to FIG. 3, other features are integrated into the data supplementer 58 via the flow component library 60 and an extended flow API 62 including remote data access and the like. In a particular embodiment the data supplementer 58 includes information required, such as credentials and the like (not shown), and procedures to follow, for example invoking a particular VPN client or the like (also not shown), in order to access sensitive data external to the flow application. This provides the data supplementer 58 with the functionality required traverse the firewall's 36 security measures, for example, and establish a connection with the sensitive data repository 28 or secure application 32 in order to retrieve and store sensitive data, for example. In particular, the retrieved data is organized and displayed in the viewport 56 by the data supplementer 58 using the extended flow component library 60 via the extended flow API 62.

Still referring to FIG. 3, each data supplementer 58 comprises a manifest 68 comprising metadata 70 that provides information about the data supplementer 56. The manifest 62 serves as a guide or reference for the system or other software components to understand and interact with the associated files, libraries, dependencies, configurations, or resources. In particular, the manifest comprises a unique ID 72, a view 74 comprising a viewport and component entry point and a content security policy 76 which provides the flow application domains which are intended to be communicated with and the purpose of the communication.

Referring back to FIG. 1 in addition to FIG. 3, the unique ID 72 is generated when creating a given data supplementer 58. The unique ID acts as the link between various uses of the data supplementer 58. Without a unique ID, a developer is unable to upload the data supplementer 58 to the flow server 14 and the data supplementer 58 is neither installable nor assignable to a viewport 56. The view 74 viewport is a point of rendering within the flow application 16. The viewport name is important and validated during upload to be linked to a known viewport 56. The content security policy 76 provides a developer with the ability to list the domains that will be connecting to via fetch or other request utilities. By limiting the content security policy 76 the data supplementer 58 is precluded from invoking unintended or malicious actions.

Still referring to FIG. 1 and FIG. 3, in order to integrate the data supplementer 58 into the flow application 16, the data supplementer 58 is uploaded to the flow application server 14 allowing them to be inspected for security and control and the like. The flow application server 14 hosts the data supplementer 5 in a domain which is unique to a given customer or client. This allows existing security tools such as browser origin policies and storage restrictions to be leveraged. Additionally, this allows the data supplementer 58 to be rendered by the flow application 16 which allows the flow application 16 to dictate what components are rendered on the viewport 56 and how they are rendered.

Still referring to FIG. 1 and FIG. 3, in a particular embodiment, during use the data supplementer 58 is invoked on a client device 22 as a separate user interface which is remote from the host flow application 16. In the particular embodiment, the data supplementer 58 is implemented using a sandboxed iframe, that is, a separate browsing context that fails within the same-origin policy. Use of an iframe provides controls and levers for certain permissions and restrictions for the remote environment. With the sandbox attribute, the iframe may have restrictions applied to it, for example, no downloads, no request triggering form submission, no top level navigation, no same origin and the like.

The host flow application 16 and the data supplementer 58 communicate using a postmessage method that provides a secure way to exchange messages and data between the flow application 16 and the data supplementer 58. This allows, for example, the flow application 16 and the data supplementer 58 to exchange information while maintaining security boundaries imposed by the client browser's 24 same-origin policy.

While this invention has been described with reference to the illustrative embodiments, this description is not intended to be construed to a limiting sense. Various modifications or combinations of the illustrative embodiment of the invention will be apparent to persons skilled in the art upon reference to the description. It is therefore intended that the described invention encompass any such modifications or embodiments.

1. A client support platform for managing sensitive data of a platform user comprising:
a flow application;
at least one flow comprising a plurality of steps to be followed by the platform user in a defined sequence and comprising at least one decision step and at least one sensitive data action step, wherein each of the at least one steps is either proceeded or followed by at least one other of the steps according to the defined sequence;
a first repository for storing the at least one flow, the repository accessible by the flow application for flow retrieval;
a secure portion comprising at least one of a second repository and a secure application comprising sensitive data of the platform user;
a platform user device comprising a display and interconnected with the flow application via the communications network for retrieving the flow from the repository using the flow application;
wherein a graphical representation of the retrieved flow is rendered on the display, the rendered graphical representation comprising a plurality of symbols each representative of respective ones of the steps wherein at least one of the steps comprises an extended data step, a plurality of texts each describing a respective one of the steps, and at least one flow arrow interconnecting a respective pair of the symbols wherein a direction of flow indicated by the flow arrow is representative of the defined sequence in which the steps represented by the symbols are to be executed;
wherein selecting the extended data step invokes a data supplementer on the platform user device;
wherein the data supplementer communicates with at least one of the second repository and the secure application for retrieving the sensitive data of the platform user;
wherein the flow application comprises an extended flow component library invokable using an extended flow API;
wherein the data supplementer renders the sensitive data on the display by invoking selected components of the extended flow component library using the extended flow API.

2. The client support platform of claim 1, wherein the sensitive data is rendered in a viewport on the display and the selected components are selected from buttons, forms, navigation menus, modals, cards and sliders.

3. The client support platform of claim 1, wherein the data supplementer further comprises information required for accessing the secure portion.

4. The client support platform of claim 3, wherein the secure portion is separated from the flow application by a firewall and further wherein the information comprises credentials for establishing a VPN via the firewall and such that the second repository and the secure application may be accessed.

5. The client support platform of claim 1, wherein the data supplementer was previously uploaded to the first repository by the platform user.

6. The client support platform of claim 1, wherein the platform user device comprises a web browser which receives, compiles and displays web pages received from the flow application.

7. The client support platform of claim 1, wherein the secure application comprises one of a CRM application and an accounting application.

8. A method for managing sensitive data of a platform user comprising:
retrieving at least one flow from a first repository via a communications network, the at least one flow comprising a plurality of steps to be followed by the platform user in a defined sequence and comprising at least one decision step and at least one sensitive data action step, wherein each of the at least one steps is either proceeded or followed by at least one other of the steps according to the defined sequence;
rendering a graphical representation of the retrieved flow on a display, the rendered graphical representation comprising a plurality of symbols each representative of respective ones of the steps wherein at least one of the steps comprises an extended data step, a plurality of texts each describing a respective one of the steps, and at least one flow arrow interconnecting a respective pair of the symbols wherein a direction of flow indicated by the flow arrow is representative of the defined sequence in which the steps represented by the symbols are to be executed; and
invoking a data supplementer by selecting the extended data step, the data supplementer communicating with a second repository or secure application for retrieving sensitive data;
wherein the data supplementer renders the sensitive data on the display using an extended flow API, the extended flow API invoking selected components of an extended flow component library.

9. The method of claim 9, wherein the sensitive data is rendered in a viewport on the display and the selected components are selected from buttons, forms, navigation menus, modals, cards and sliders.

10. The method of claim 9, wherein the data supplementer further comprises information required for accessing the secure portion.

11. The method of claim 10, wherein the sensitive data is separated from the flow application by a firewall and further wherein the information comprises credentials for establishing a VPN via the firewall and such that the second repository and the secure application may be accessed.

12. The method of claim 9, wherein the secure application comprises one of a CRM application and an accounting application.

13. A computer readable memory having recorded thereon statements and instructions for execution by a computer, said statements and instructions comprising:
instructions for retrieving at least one flow from a first repository via a communications network, the at least one flow comprising a plurality of steps to be followed by the platform user in a defined sequence and comprising at least one decision step and at least one sensitive data action step, wherein each of the at least one steps is either proceeded or followed by at least one other of the steps according to the defined sequence;
instructions for rendering a graphical representation of the retrieved flow on a display, the rendered graphical representation comprising a plurality of symbols each representative of respective ones of the steps wherein at least one of the steps comprises an extended data step, a plurality of texts each describing a respective one of the steps, and at least one flow arrow interconnecting a respective pair of the symbols wherein a direction of flow indicated by the flow arrow is representative of the defined sequence in which the steps represented by the symbols are to be executed; and
instructions for invoking a data supplementer by selecting the extended data step, the data supplementer communicating with a second repository or secure application for retrieving sensitive data;
wherein the data supplementer renders the sensitive data on the display using an extended flow API, the extended flow API invoking selected components of an extended flow component library.

14. The computer readable memory of claim 13, wherein the sensitive data is rendered in a viewport on the display and the selected components are selected from buttons, forms, navigation menus, modals, cards and sliders.

15. The computer readable memory of claim 13, wherein the data supplementer further comprises information required for accessing the secure portion.

16. The computer readable memory of claim 15, wherein the sensitive data is separated from the flow application by a firewall and further wherein the information comprises credentials for establishing a VPN via the firewall and such that the second repository and the secure application may be accessed.

17. The computer readable memory of claim 13, wherein the secure application comprises one of a CRM application and an accounting application.
